(19) United States
(12) Patent Application Publication
(10) Pub. No.: US 2026/0230708 A1
(43) Pub. Date: Aug. 6, 2026

(54) OPTICAL APPARATUS, IMAGE PICKUP APPARATUS, CONTROL METHOD, CONTROL APPARATUS, AND STORAGE MEDIUM

(71) Applicant: CANON KABUSHIKI KAISHA, Tokyo (JP)

(72) Inventor: FUYA MIZUOCHI, Saitama (JP)

(21) Appl. No.: 19/448,280

(22) Filed: Jan. 14, 2026

(30) Foreign Application Priority Data
Jan. 28, 2025 (JP) 2025-012352

(51) Int. Cl. H04N 23/69; G02B 7/09; G03B 5/00; H04N 23/67

(52) U.S. Cl. CPC H04N 23/69; G02B 7/09; G03B 5/00; H04N 23/672; G03B 2205/0046

(57) ABSTRACT

An optical apparatus may include a first optical element movable within a first range in an optical axis direction, a second optical element movable within a second range in the optical axis direction, a first stepping motor configured to move the first optical element, a second stepping motor configured to move the second optical element, one or more memories storing instructions, and one or more processors that, upon execution of the instructions, operate to control the first stepping motor and the second stepping motor by switching between open-loop control and feedback control. A part of each of the first range and the second range overlaps each other in the optical axis direction.

### BACKGROUND

### Field of the Technology

The aspect of the disclosure relates to one or more embodiments of a lens apparatus, an image pickup apparatus, a control method, a control apparatus, and a storage medium.

### Description of the Related Art

Lens apparatuses that use a stepping motor to drive a lens have been conventionally known. Japanese Patent Application Laid-Open No. 2015-22136 discloses a control apparatus that controls a stepping motor by switching between open-loop control and feedback control.

### SUMMARY

An optical apparatus according to one aspect of the disclosure may include a first optical element movable within a first range in an optical axis direction, a second optical element movable within a second range in the optical axis direction, a first stepping motor configured to move the first optical element, a second stepping motor configured to move the second optical element, one or more memories storing instructions, and one or more processors that, upon execution of the instructions, operate to control the first stepping motor and the second stepping motor by switching between open-loop control and feedback control. A part of each of the first range and the second range overlaps each other in the optical axis direction. An image pickup apparatus having the above optical element apparatus also constitutes another aspect of the disclosure. A control method of the above optical apparatus and a control apparatus corresponding to the above control method also constitute another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of an imaging system according to each embodiment.

FIG. 2 explains advance angle control according to each embodiment.

FIG. 3 illustrates a relationship between an advance angle and a speed in each embodiment.

FIG. 4 explains electronic cam data in each embodiment.

FIG. 5 explains a movable range of each of a zoom lens and a focus lens in each embodiment.

FIG. 6 illustrates a speed characteristic of open-loop control and advance angle control in each embodiment.

FIG. 7 is a flowchart illustrating a control method according to a first embodiment.

FIG. 8 illustrates the likelihood of a collision between the zoom lens and the focus lens in a second embodiment.

FIG. 9 illustrates a positional relationship between a zoom lens and a focus lens in the second embodiment.

FIG. 10 is a flowchart illustrating a control method according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

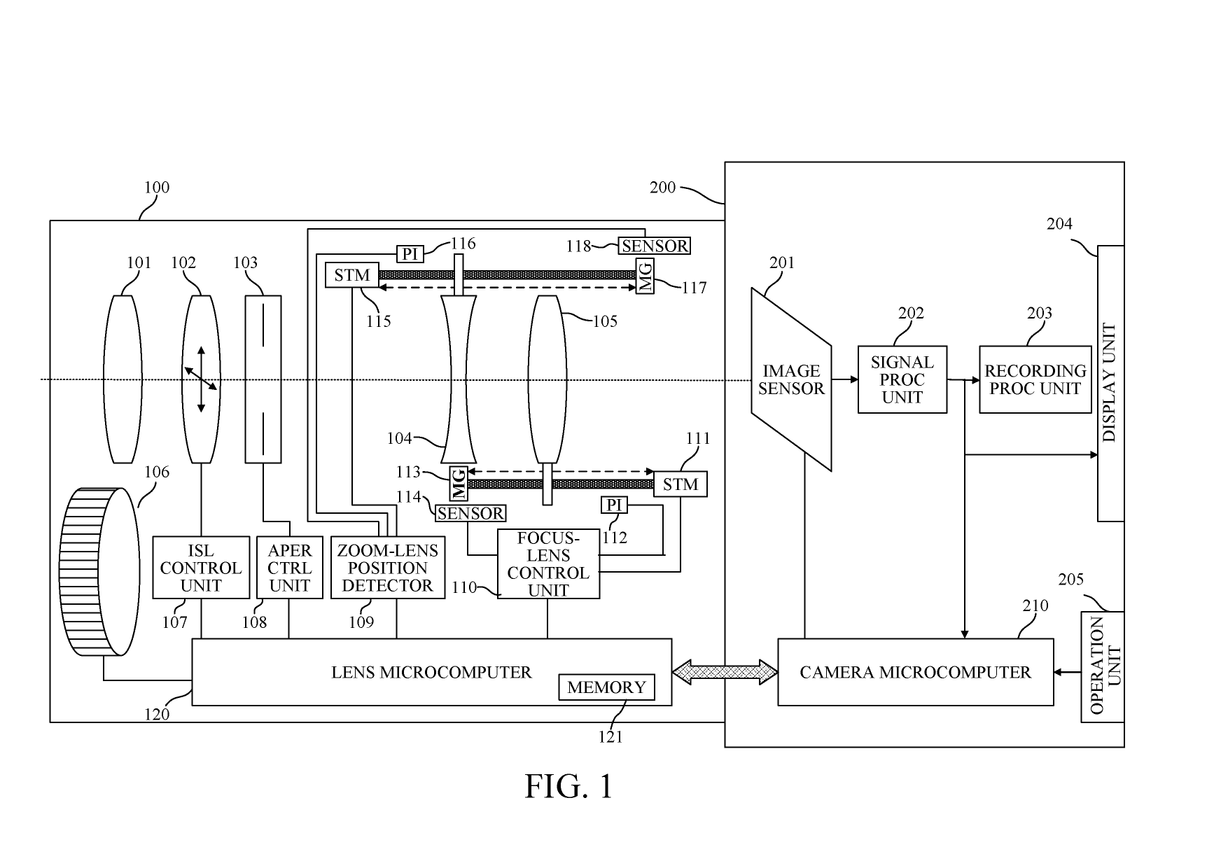

Referring now to FIG. 1, an imaging system 10 according to each embodiment will be described. FIG. 1 illustrates the configuration of the imaging system 10. The imaging system 10 includes a camera body (image pickup apparatus) 200 and a lens apparatus (interchangeable lens, optical apparatus) 100 that is attachable to and detachable from the camera body 200. However, each embodiment is not limited to this configuration, and is also applicable to an image pickup apparatus in which the camera body and the lens apparatus are integrated.

The lens apparatus 100 is mechanically and electrically connected to the camera body 200 via an interchangeable lens mount and a camera body mount (not illustrated). The lens apparatus 100 receives power from the camera body 200 via a power terminal (not illustrated) provided on the mounts. A lens microcomputer 120 in the lens apparatus 100 is a control unit that controls a variety of actuators (stepping motors) described later using the power received from the camera body 200. The camera microcomputer 210 of the camera body 200 communicates with the lens apparatus 100 via a communication terminal (not illustrated) provided on the mounts, and controls the lens apparatus 100 by transmitting control commands.

### CAMERA BODY

Next, the configuration of the camera body 200 will be described. The camera body 200 includes an image sensor 201 including a phase-difference autofocus (AF) sensor, a signal processing unit 202, a recording processing unit 203, a display unit 204, an operation unit 205, and a camera microcomputer 210.

The image sensor 201 is a photoelectric conversion element such as a CMOS sensor, and photoelectrically converts an object image formed by the imaging optical system in the lens apparatus 100 and outputs an electrical signal (analog signal). An A/D conversion circuit (not illustrated) converts the analog signal output from the image sensor 201 into a digital signal. The signal processing unit 202 performs a variety of image processing operations on the digital signal from the A/D conversion circuit to generate a video signal. The signal processing unit 202 also generates focus information indicating the contrast state of the object image, that is, the focus state of the imaging optical system, and luminance information representing the exposure state from the video signal.

The image sensor 201 can detect the focus state of the object image using a phase-difference detecting method. The signal processing unit 202 processes a pair of phase difference signals of the object image obtained from the light incident through a microlens that performs pupil division, for the focus detecting pixels included in the image sensor 201. This allows the signal processing unit 202 to determine a defocus amount corresponding to the phase-difference signal and generate focus information.

The signal processing unit 202 outputs a video signal to the display unit 204, and the display unit 204 displays the video signal as a live-view image that is used for checking the composition and focus status. More specifically, the display unit 204 is a rear liquid crystal display (LCD) or electronic viewfinder of the camera body 200. The signal processing unit 202 outputs the video signal to the recording processing unit 203, and the recording processing unit 203 stores the video signal as still or moving image data in an external memory (not illustrated).

The camera microcomputer 210, as a camera control unit, controls the camera body 200 according to inputs from the imaging instruction switch and a variety of setting switches included in the operation unit 205. The camera microcomputer 210 also transmits control commands to the lens microcomputer 120 via a camera communication unit (not illustrated) provided on the mounts. The control commands include signals related to, for example, a light amount adjustment operation of an aperture (stop) unit 103 according to the luminance information and the focusing operation of a focus lens 105 according to the focus information including the defocus amount.

### LENS APPARATUS

Next, the configuration of the lens apparatus 100 will be described. The lens apparatus 100 includes the imaging optical system, a variety of control units that control a variety of actuators that drive each lens constituting the imaging optical system, an operation ring 106, a lens microcomputer 120, and a SW operation unit (not illustrated).

The lens microcomputer 120 is a control unit that controls the operation of each part within the lens apparatus 100. It receives control commands transmitted from the camera body 200 via the communication unit and receives requests for transmission of lens data. The lens microcomputer 120 also performs lens control corresponding to the control commands and transmits lens data corresponding to the transmission requests to the camera body 200.

The lens apparatus 100 has a function to transition from an active mode, which is a normal operating state, to a sleep mode, which is a low power consumption state, in accordance with a sleep command from the camera body 200. In the sleep mode, the power supply to the peripheral circuits of the lens apparatus 100 is shut off, and the clock oscillation circuit of the lens microcomputer 120 is stopped, achieving a low power consumption state in which an operation is suspended. The lens apparatus 100 transitions to the active mode in accordance with a sleep release command from the camera body 200 and performs the normal operation such as focusing and aperture control, which will be described later.

According to commands related to light amount adjustment and focusing among the control commands, the lens microcomputer 120 issues instructions to an aperture control unit 108 or a focus-lens (FL) control unit 110 to drive the aperture unit 103 or the focus lens 105. This performs light amount adjustment processing and autofocus processing (AF processing) to control the focusing operation. The lens microcomputer 120 can also issue instructions to the focus lens control unit 110 to drive the focus lens 105 according to the operation amount of the operation ring 106, thereby performing a focusing operation using so-called manual focus (MF). The operation amount of the operation ring 106 is calculated by the lens microcomputer 120 by processing the signal output from a sensor such as a photo-interrupter (not illustrated).

The imaging optical system includes a field lens 101, an image stabilizing lens 102, the aperture unit 103 for adjusting the light amount, a zoom lens (first lens, first optical element) 104 for magnification variation, and the focus lens (second lens, second optical element) 105 for focusing. This lens configuration, where the focus lens 105 is positioned behind the zoom lens when viewed from the object side, is called a rear focus lens and is commonly used for reducing the size of the lens interchangeable type camera. In this embodiment, the zoom lens 104 is positioned closer to the object than the focus lens 105, but it is not limited to this configuration.

The field lens 101 adjusts a traveling direction of peripheral light in the object image. The image stabilizing lens 102 reduces image blur caused by camera shake, etc., by moving in a direction orthogonal to the optical axis of the imaging optical system. An image-stabilizing-lens (ISL) control unit 107 outputs a drive signal and drives an image stabilizing actuator according to a command from the lens microcomputer 120, based on the vibration (shake) detected by a vibration gyro or acceleration sensor (not illustrated). This performs image stabilizing processing that controls the shift operation of the image stabilizing lens 102.

The aperture unit 103 has aperture blades and a sensor such as a Hall element. The state of the aperture blades is detected by the sensor and output to the lens microcomputer 120. The aperture control unit 108 outputs a drive signal and drives an actuator such as a stepping motor or a voice coil motor according to a command from the lens microcomputer 120. This allows the aperture unit 103 to adjust the light amount. The zoom lens 104 is movable in the direction along the optical axis (optical axis direction) indicated by a dashed line in FIG. 1, and receives commands from the lens microcomputer 120 to output a drive signal to drive a stepping motor 115. A leadscrew coaxial with a rotor of the stepping motor 115 is rotationally driven, and the zoom lens 104, which is mechanically connected to a rack (not illustrated) that meshes with the leadscrew, moves to vary the magnification.

The reference position of the stepping motor 115 is determined by a photo-interrupter 116. In a case where a light-shielding plate integrated with the zoom lens 104 (not illustrated) is inserted into the photo-interrupter 116, the output of the photo-interrupter 116 changes. This changed position is used as the reference position, and the absolute position can be detected by counting the changes in the excitation phase.

A magnet 117 is provided at the tip of the leadscrew. The magnet 117 rotates together with the leadscrew. The Hall sensor 118 detects changes in the magnetic field due to the rotation of the magnet 117 and outputs these changes to the lens microcomputer 120. As described later, detecting the rotor position of the stepping motor 115 from the change in the magnetic field and controlling the speed based on the excitation phase exciting the stepping motor 115 will be referred to as advance angle control.

The drive unit that drives the focus lens 105 includes a stepping motor 111, a photo-interrupter 112, a magnet 113, a Hall sensor 114, and a rack (not illustrated). Since the configuration is similar to that of the zoom lens 104, a description thereof will be omitted, but the focus lens 105 moves for focusing.

In such a rear-focus type magnification optical system, the focus lens 105 corrects image plane fluctuations associated with magnification changes caused by the zoom lens 104. Zoom tracking control is performed to correct image plane variations that occur when the zoom lens 104 is moved to perform magnification variation, by moving the focus lens 105, thereby maintaining the in-focus state. To perform zoom tracking control, a memory 121 provided in the lens microcomputer 120 stores information on electronic cam data (tracking curve). The electronic cam data illustrates a relationship between the position of the zoom lens 104 and the position of the focus lens 105, which are set to maintain the in-focus state according to the object distance. The electronic cam data information may be stored in a memory provided separately from the lens microcomputer 120.

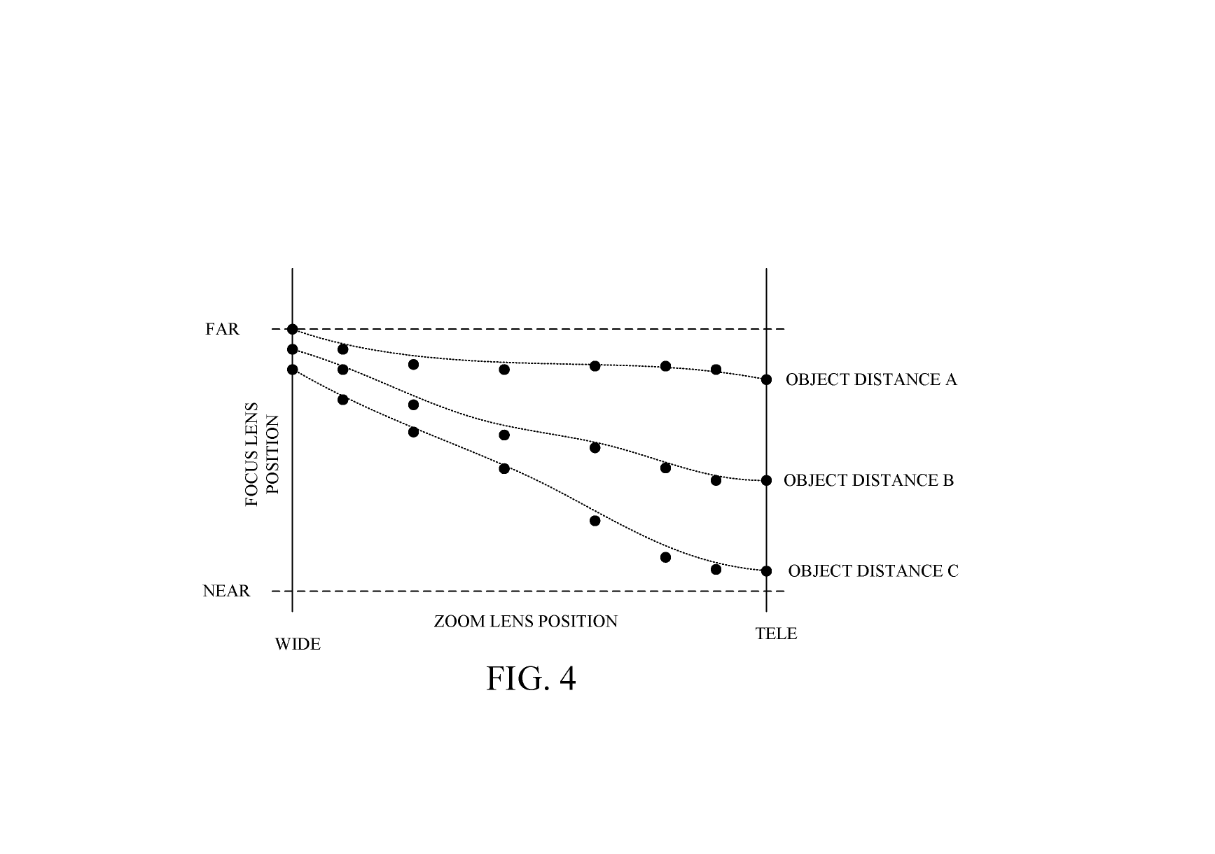

FIG. 4 explains the electronic cam data. In FIG. 4, the horizontal axis represents the position of the zoom lens 104 (zoom lens position) (WIDE represents a wide-angle end and TELE represents a telephoto end), and the vertical axis represents the position of the focus lens 105 (focus lens position) (FAR represents an infinity end and NEAR represents a close distance end). Based on the electronic cam data, the lens microcomputer 120 issues a control command to the focus lens control unit 110 and drives the focus lens 105 to perform tracking control. As illustrated in FIG. 4, the electronic cam data actually stored in the memory 121 is data corresponding to several representative object distances A to C, and is data illustrating the focus lens position for representative zoom lens positions (representative points). For zoom lens positions other than the representative points, the ratio of the distances to a plurality of representative points close to the zoom lens position other than the representative points is calculated, and the desired focus lens position is calculated by linear interpolation according to that ratio. Thereby, the in-focus state can be maintained during the magnification variation operation.

### ADVANCE ANGLE CONTROL

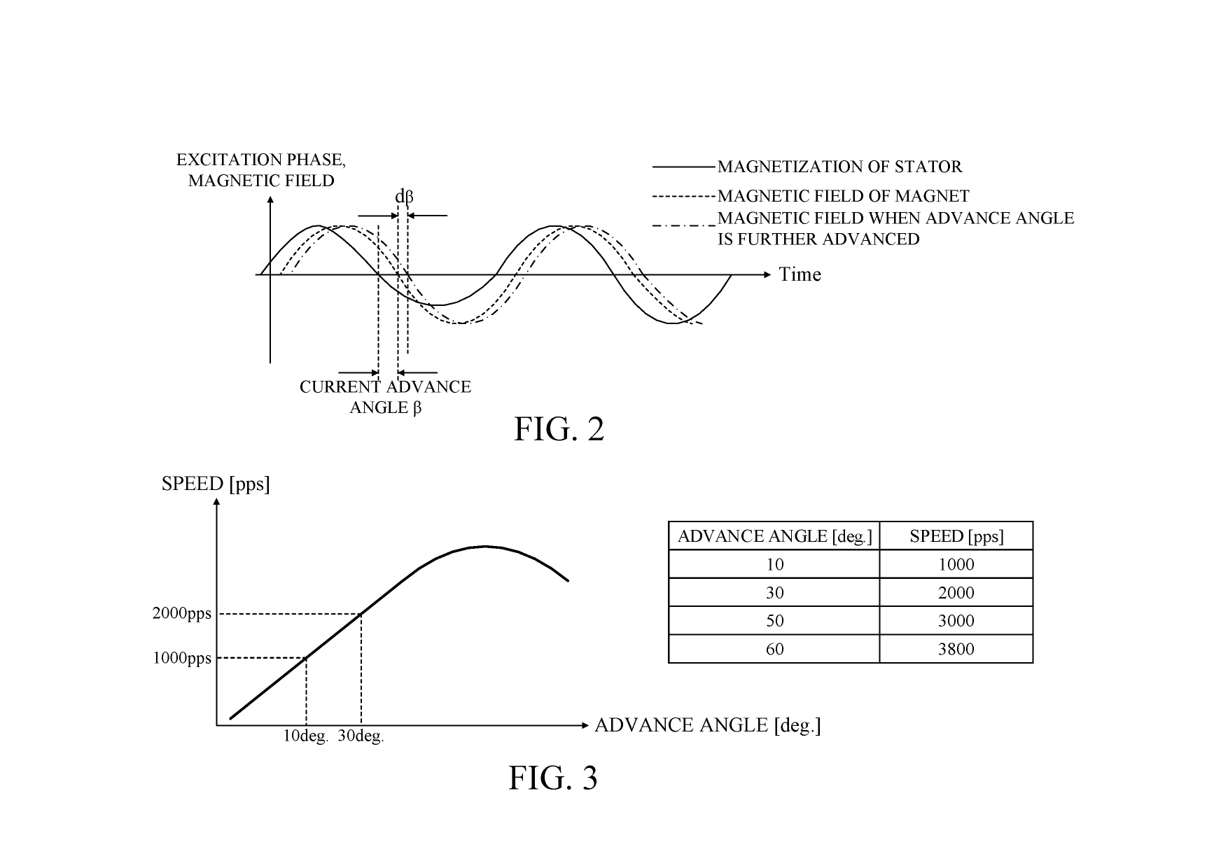

Next, the advance angle control will be described with reference to FIGS. 2 and 3. FIG. 2 explains microstep driving that applies a sinusoidal excitation waveform to the motor. During control of a stepping motor in open-loop control, an excitation voltage equivalent to a speed with sufficient torque margin is generated, and the motor is driven via a motor driver. That is, the open-loop control can only be used up to a speed at which step-out does not occur under a variety of conditions.

On the other hand, in the case of feedback control, the rotor position is obtained from the encoder output, and the excitation voltage is generated based on the excitation waveform and the rotor position so that the target speed is achieved. FIG. 3 illustrates a relationship between the advance angle and speed. As illustrated in FIG. 3, the speed corresponding to the advance angle is held as table data, and the target advance angle value for the target speed is calculated. Control is performed so that the excitation waveform and the rotor position (current advance angle β in FIG. 2) become the target advance angle (current advance angle β+Δβ in FIG. 2). By repeatedly advancing the advance angle until the target speed is achieved, the desired speed can be achieved.

Conversely, during deceleration, the advance angle is repeatedly delayed until the target speed is achieved, and the speed is brought to the desired speed. During constant speed driving, the advance and retreat of the advance angle are repeatedly performed, and control is performed so that the speed converges to near the desired speed. In addition to manipulating the advance angle, the responsiveness to speed can be improved by changing the voltage applied to the stepping motor. It is also conceivable to converge the speed to the target speed by repeatedly increasing the voltage in a case where the current speed is lower than the target speed, and decreasing the voltage in a case where the current speed is higher than the target speed. This type of feedback control is called advance angle control.

As described above, since the excitation voltage is generated based on the current excitation position and the rotor position, high-speed driving without step-out can be achieved. In other words, compared to the open-loop control, which requires setting a generous upper speed limit, the feedback control (advance angle control) allows the stepping motor to be used up to a speed closer to its performance limit, enabling high-speed driving of the lens. Therefore, in each embodiment, the stepping motor is basically controlled by the open-loop control, but it may be controlled by feedback control under predetermined conditions.

In FIG. 2, for simplicity of description, the magnetic field of the magnet and the one-phase excitation output timing of the A-phase of the stator are aligned. In reality, it is necessary to align the relationship between the mounting phase of the sensor magnet and the excitation phase of the motor, but since this is a known technology, a description thereof will be omitted.

In order to achieve miniaturization and high image quality of the lens apparatus, each embodiment may increase the degree of freedom in optical design and configure the movable ranges (first range and second range) of the lenses so that they partially overlap each other in order to efficiently utilize the space within the lens barrel. In a case where the movable ranges of the lenses overlap each other, it becomes unnecessary to provide separate mechanisms by sharing rails and guides as a mechanical mechanism, and the reduction in the number of parts is advantageous for miniaturization. Also, in a case where the movable ranges of the lenses overlap each other, collisions may be avoided and high-speed driving of each lens may be achieved. The above advance angle control mechanism for the overlapping portion of the movable ranges can prevent collisions and enable high-speed driving, thereby improving user convenience.

The following describes each embodiment in detail.

### FIRST EMBODIMENT

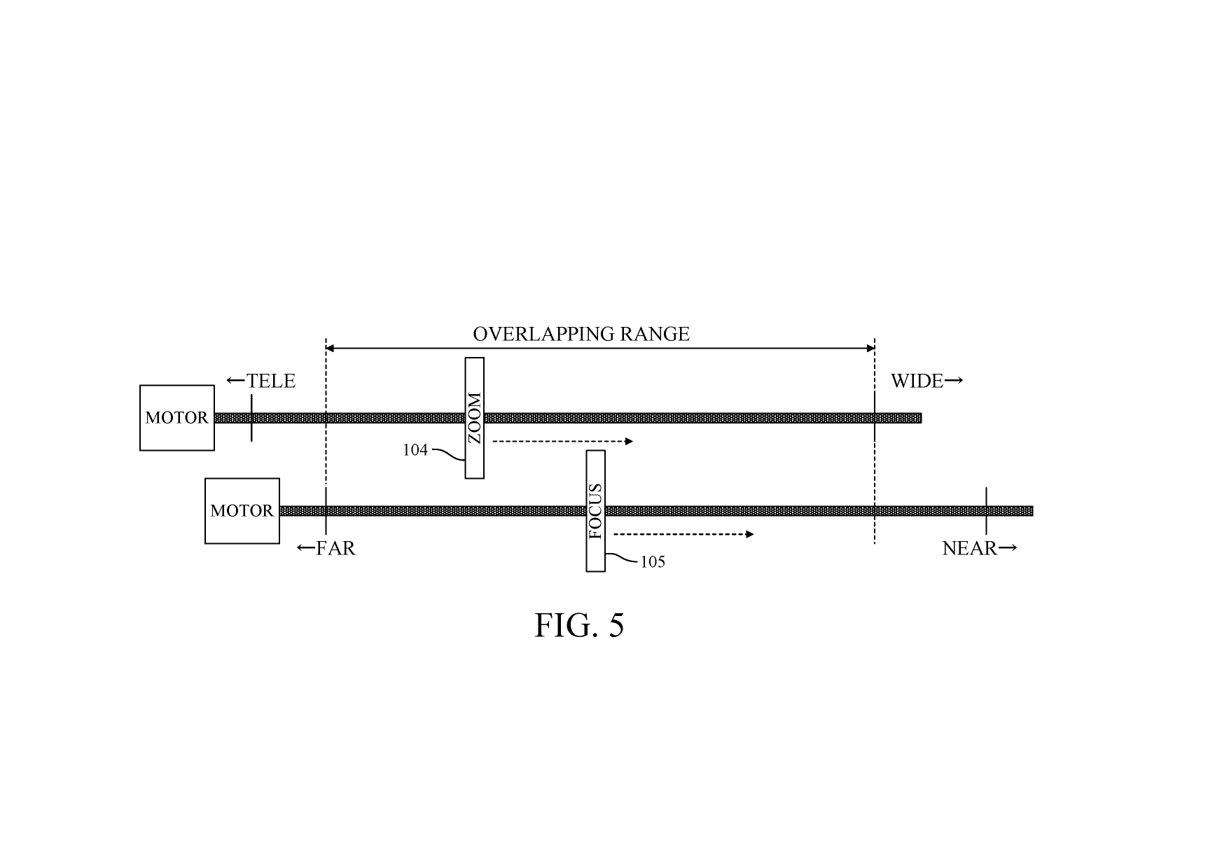

First, a first embodiment of the disclosure will be described. FIG. 5 explains the respective movable ranges (strokes) of the zoom lens 104 and the focus lens 105. A range indicated by a solid arrow in FIG. 5 is an overlapping range of the movable range (first range) of the zoom lens 104 and the movable range (second range) of the focus lens 105. That is, in the optical axis direction, the movable range of the focus lens 105 and the movable range of the zoom lens 104 include a range that overlaps each other (overlapping range).

For example, when the zoom lens 104 is driven in the wide-angle direction (to the right) (direction toward the wide-angle end), the focus lens 105 is driven while being tracking-controlled by the above electronic cam data. However, in a case where the movement of the focus lens 105 is slow, there may be collision with the zoom lens 104. Therefore, the movable speed of the focus lens 105 may be set to be equal to or greater than the movable speed of the zoom lens 104.

As discussed above, between the open-loop control and the advance angle control (feedback control) in a stepping motor, advance angle control allows for faster driving. However, the advance angle control takes time for acceleration and deceleration, and it is difficult to maintain a constant speed. Therefore, compared to open-loop control, the advance angle control results in a larger deviation between the target speed and the actual speed (speed fluctuation).

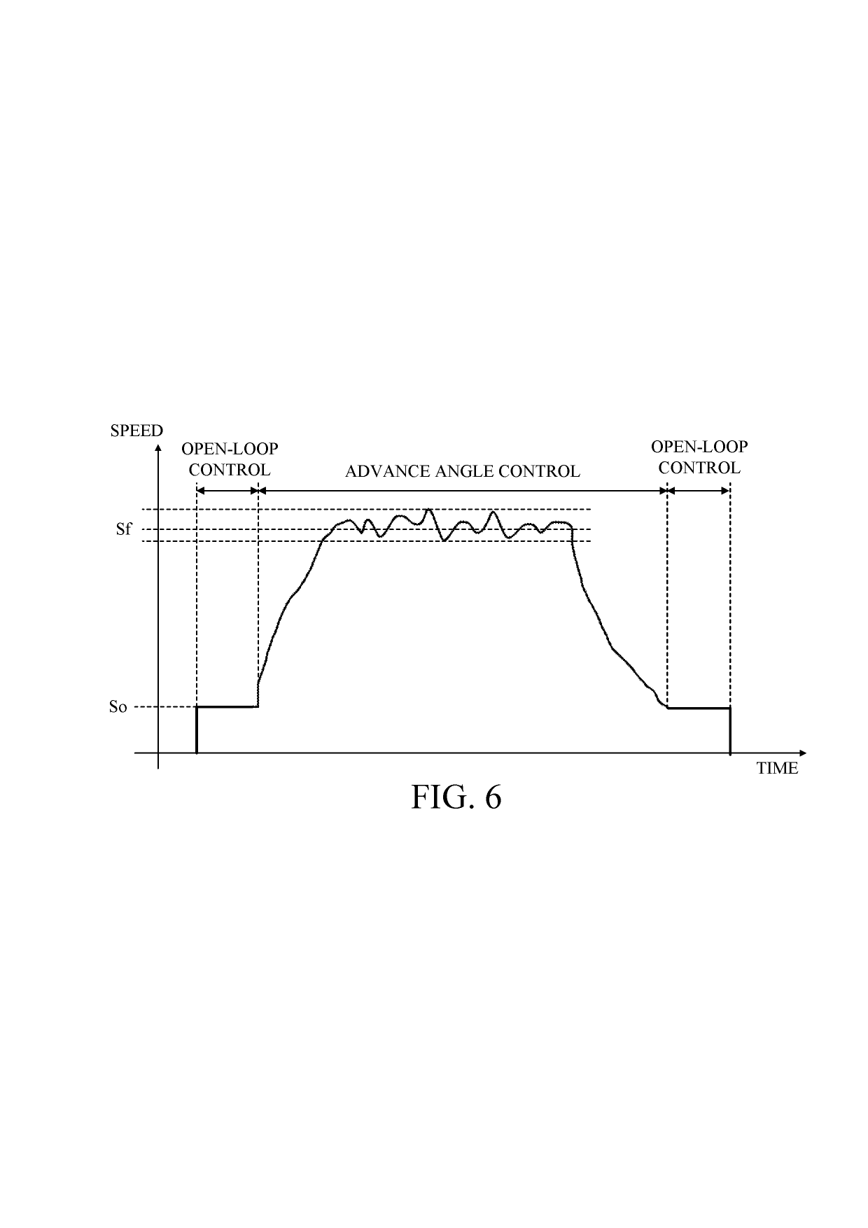

FIG. 6 illustrates the speed characteristics of the open-loop control and the advance angle control, respectively. In FIG. 6, the horizontal axis represents time, and the vertical axis represents speed. In a case where the stepping motor starts driving, to stabilize the rotational unevenness of the rotor in the stepping motor, the stepping motor is driven using the open-loop control at speed So. The speed So may be a speed at which the open-loop control is available, and may be the pull-in speed, but may be the pull-out speed. Here, in a case where the speed at which the switching between the open-loop control and the advance angle control occurs is So, then if the speed command is equal to or less than So, the open-loop control is performed, and the system does not transition to the advance angle control. On the other hand, if the speed command exceeds So, the system transitions to the following advance angle control.

After the rotation is stabilized by driving with the open-loop control, the system transitions to the advance angle control, and the driving speed of the stepping motor is accelerated towards target speed Sf while changing the advance angle. After the target speed is achieved, the advance angle control is performed to maintain the speed Sf, and when the driving amount to the target position is less than a predetermined value, the deceleration processing is started. In the deceleration processing, deceleration is performed by changing the advance angle, and when the speed is less than a predetermined value, the system transitions to the open-loop control and stops when the speed reaches the target position. Thus, due to speed fluctuations, and a long time required to switch to the advance angle control and thus lowered responsiveness, the tracking control may be driven with the open-loop control.

However, the driving speed of the zoom lens 104 is greatly related to the zooming operability of the user. As discussed above, if the zoom lens 104 is too fast, it will collide with the focus lens 105, so the focus lens 105 may be driven by properly switching between the open-loop control and the advance angle control.

### CONTROL METHOD OF LENS APPARATUS

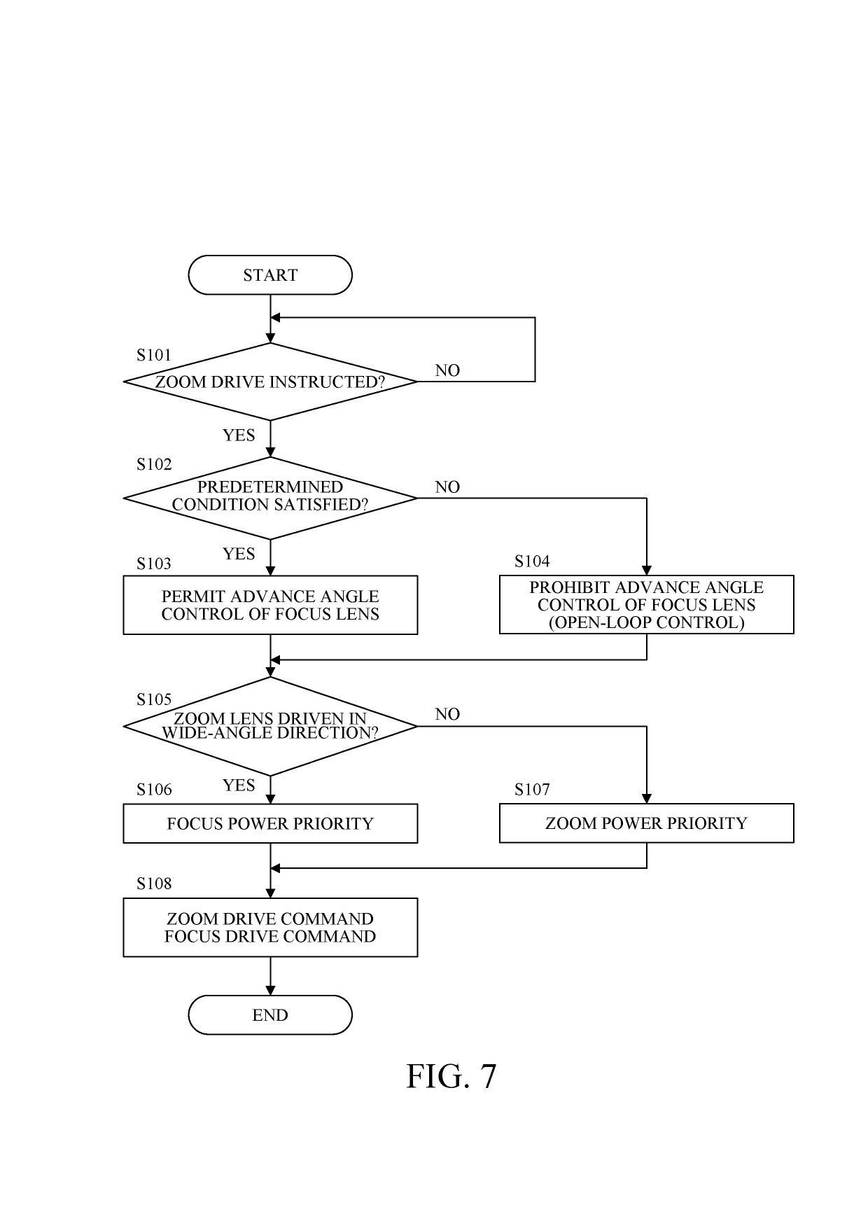

Referring now to FIG. 7, a control method of the lens apparatus 100 according to this embodiment will be described. Each step in FIG. 7 is mainly executed by the lens microcomputer 120, or by each part according to the instructions of the lens microcomputer 120. However, this embodiment is not limited to this example, and may be executed by the camera microcomputer 210, or by each part according to the instructions of the camera microcomputer 210.

First, in step S101, the lens microcomputer 120 determines whether or not there is a drive instruction for the zoom lens 104 (zoom drive instruction). The zoom drive instruction is given to the lens apparatus 100 from the camera body 200 via communication by the user operation of the operation unit 205, or by the operation of the operation ring 106 of the lens apparatus 100. In a case where no zoom drive instruction is received, the determination in step S101 is repeated. On the other hand, in a case where a zoom drive instruction is received, the flow proceeds to step S102.

In step S102, the lens microcomputer 120 determines whether or not a predetermined condition is met. That is, the lens microcomputer 120 determines whether or not to permit driving by the advance angle control to drive the focus lens 105. The predetermined condition may include, for example, a condition related to the speed of the zoom lens 104. In this embodiment, for example, in a case where the speed instruction of the zoom lens 104 is equal to or greater than a predetermined speed, the advance angle control may be permitted. Here, the predetermined speed refers to a speed higher than the speed So, which is the speed required for the focus lens 105 to track the electronic cam data when the zoom lens 104 performs tracking control at the instructed speed. In a case where the speed required to track the electronic cam data is higher than the speed So, the lens microcomputer 120 permits the advance angle control of the focus lens 105. Alternatively, the predetermined speed (predetermined condition) may be determined using only the driving speed of the zoom lens 104. That is, in a case where the speed instruction of the zoom lens 104 is a predetermined speed higher than the speed So, the advance angle control of the focus lens 105 may be permitted.

Another conceivable predetermined condition is that the focus lens 105 is under tracking control and a tracking delay (tracking delay amount) of a predetermined amount or more occurs in the tracking of the electronic cam data. In a case where a tracking delay occurs in the focus lens 105 relative to the electronic cam data, an in-focus state cannot be maintained. The predetermined amount of tracking delay may be one depth or more, which is an indicator by which the user can recognize that the image is out of focus. One depth is F-number × δ (permissible circle of confusion), and permitting the advance angle control of the focus lens 105 can provide high-speed driving, and improve the tracking delay.

Another predetermined condition is that the advance angle control of the focus lens 105 may be permitted in a case where the zoom lens 104 is already under advance angle control. Another predetermined condition is that the advance angle control of the focus lens 105 may be permitted according to the relative positional relationship between the zoom lens 104 and the focus lens 105. In a case where the distance between the position of the zoom lens 104 and the position of the focus lens 105 is less than a predetermined distance, that is, in a case where the distance between them is short, the advance angle control of the focus lens 105 is permitted to avoid collisions. Thus, driving the focus lens 105 at a high speed can accelerate the focus lens 105 to avoid collisions.

Thus, a plurality of conditions are conceivable as the predetermined condition, and satisfying at least one of these conditions can select optimal control. For example, in a case where the determination is made solely based on the driving speed of the zoom lens 104, the determination processing can be simple, and the processing time can be reduced. Alternatively, in a case where the determination is made based on a plurality of conditions, such as the tracking delay amount relative to the electronic cam data of the focus lens 105, the speed of the zoom lens 104, and the distance between the zoom lens 104 and the focus lens 105, focus tracking performance during the magnification variation operation can be improved while collisions can be avoided. Making determination in this combined manner can improve performance.

That is, the predetermined condition includes, for example, at least one of electronic cam data, the speed of the zoom lens 104, the control state of the stepping motor 115, the position of the zoom lens 104 or the focus lens 105, and the tracking delay amount. Here, the control state indicates whether the control is performed by the open-loop control or the feedback control. The tracking delay amount is a tracking delay amount of the focus lens 105 relative to the zoom lens 104 in the electronic cam data.

In a case where the predetermined condition is met in step S102, the flow proceeds to step S103. On the other hand, in a case where the predetermined condition is not met, the flow proceeds to step S104.

In step S103, the lens microcomputer 120 permits the advance angle control of the focus lens 105 and the flow proceeds to step S105. In step S104, the lens microcomputer 120 does not permit the advance angle control of the focus lens 105 and the flow proceeds to step S105. Even during the advance angle control, in a case where the predetermined condition is no longer met in step S102, the flow switches from the advance angle control to the open-loop control by transitioning to step S104.

Next, in step S105, the lens microcomputer 120 determines the driving direction of the zoom lens 104. In a case where the driving direction is the wide-angle direction (the direction approaching the wide-angle end), the flow proceeds to step S106. On the other hand, in a case where the driving direction is the telephoto direction (the direction approaching the telephoto end), the flow proceeds to step S107. In a case where the driving direction of the zoom lens 104 is the wide-angle direction, that is, in a case where the focus lens 105 is in the direction of being chased by the zoom lens 104, in step S106, the lens microcomputer 120 preferentially allocates power to the focus lens 105.

As described above, in the advance angle control, a speed control is also performed by changing the voltage applied to the stepping motor. However, since the power supplied from the camera body 200 is limited, it is often difficult to provide high power to both the zoom lens 104 and the focus lens 105. In this case, in a case where the speed of the focus lens 105 is insufficient, there is a likelihood of collision with the zoom lens 104, so the collision is avoided by preferentially allocating power to the focus lens 105.

On the other hand, when the driving direction of the zoom lens 104 is in the telephoto direction, in step S107, the lens microcomputer 120 preferentially allocates power to the zoom lens 104. Basically, the focus lens 105 performs tracking control based on the position of the zoom lens 104, so there is no collision. However, in order to correct the breathing that occurs due to changes in the angle of view according to the position of the focus lens 105, the zoom lens 104 may be controlled. That is, control that suppresses breathing by performing tracking control of the zoom lens 104 based on the position information on the focus lens 105 is conceivable, and the zoom lens 104 may be in a direction where it is chased by the focus lens 105.

At this time, in a case where the speed of the zoom lens 104 is insufficient, there is a likelihood of collision with the focus lens 105, so the collision is avoided by preferentially allocating power to the zoom lens 104. Here, the method of preferentially allocating power is, for example, setting the upper limit of the voltage in the control that changes the voltage in the advance angle control.

Next, in step S108, the lens microcomputer 120 outputs a drive command to a zoom-lens (ZL) control unit 109 and the focus lens control unit 110 to drive the zoom lens 104 and the focus lens 105.

By repeating steps S101 to S108 at predetermined periods, it is possible to drive the zoom lens 104 and the focus lens 105 while properly switching between the open-loop control and the advance angle control.

In the lens apparatus 100 according to this embodiment, the movable range of the zoom lens 104 and the movable range of the focus lens 105 include a range that overlaps each other in the optical axis direction. The lens microcomputer 120 controls each of the stepping motors 111 and 115 by switching between the open-loop control and the feedback control. In a case where the lens microcomputer 120 controls at least one of the stepping motors 111 and 115 with the feedback control, it may make the first power supplied to the stepping motor 115 and the second power supplied to the stepping motor 111 different from each other. In a case where the zoom lens 104 moves in the first direction (e.g., wide-angle direction), the lens microcomputer 120 may make the second power greater than the first power. In a case where the zoom lens 104 moves in the second direction opposite to the first direction (e.g., telephoto direction), the lens microcomputer 120 may make the first power greater than the second power.

Thus, this embodiment mounts an encoder capable of detecting the rotation angle on the stepping motor, sets the movable ranges of the multiple independently driven lenses so that they overlap each other, and properly switches the open-loop control and the feedback control. This embodiment can achieve miniaturization and high image quality (high optical performance) of the lens apparatus, and improve user convenience.

### SECOND EMBODIMENT

Next, a second embodiment of the disclosure will be described. This embodiment is a modification of the control method of the imaging system 10 described in the first embodiment, with the following changes.

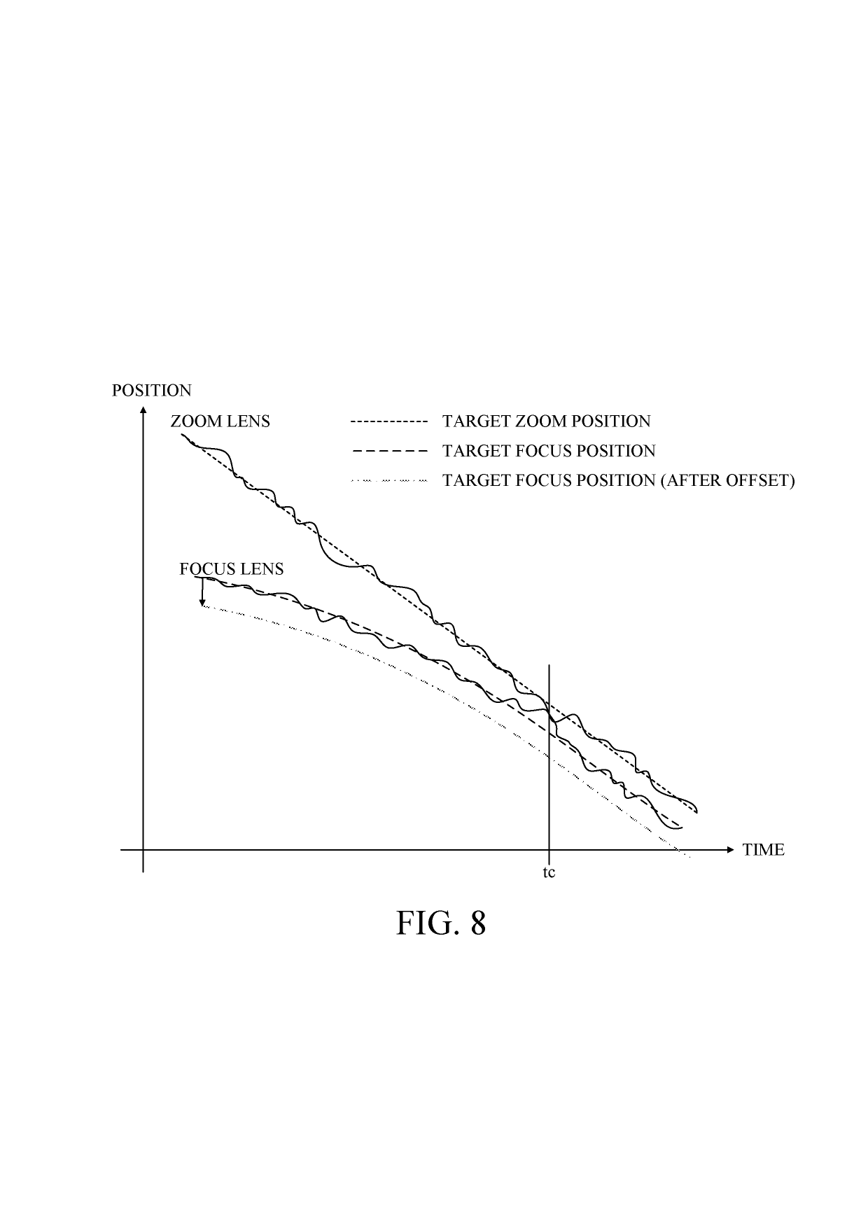

Referring to FIG. 8, a positional relationship between the zoom lens 104 and the focus lens 105 in this embodiment will be described. FIG. 8 illustrates the likelihood of collision between the zoom lens 104 and the focus lens 105. In FIG. 8, the horizontal axis represents time, and the vertical axis represents the respective positions of the zoom lens 104 and the focus lens 105. The positions of the zoom lens 104 and the focus lens 105 are expressed on the same coordinate system.

During driving of the zoom lens 104 using the advance angle control, it is driven based on the target zoom position, but as discussed above, the advance angle control has speed fluctuations. The same applies to the focus lens 105, and if the speed fluctuations of both lenses are biased towards the side where they approach each other, there is a likelihood that the zoom lens 104 and the focus lens 105 will collide (time tc in FIG. 5).

In a case where such a collision occurs, the stepping motor will lose synchronization, and subsequent position control will become impossible. To avoid this, the target focus position in FIG. 8 is corrected in the direction away from the zoom lens 104, and the collision can be prevented by performing a control to track the corrected target focus position.

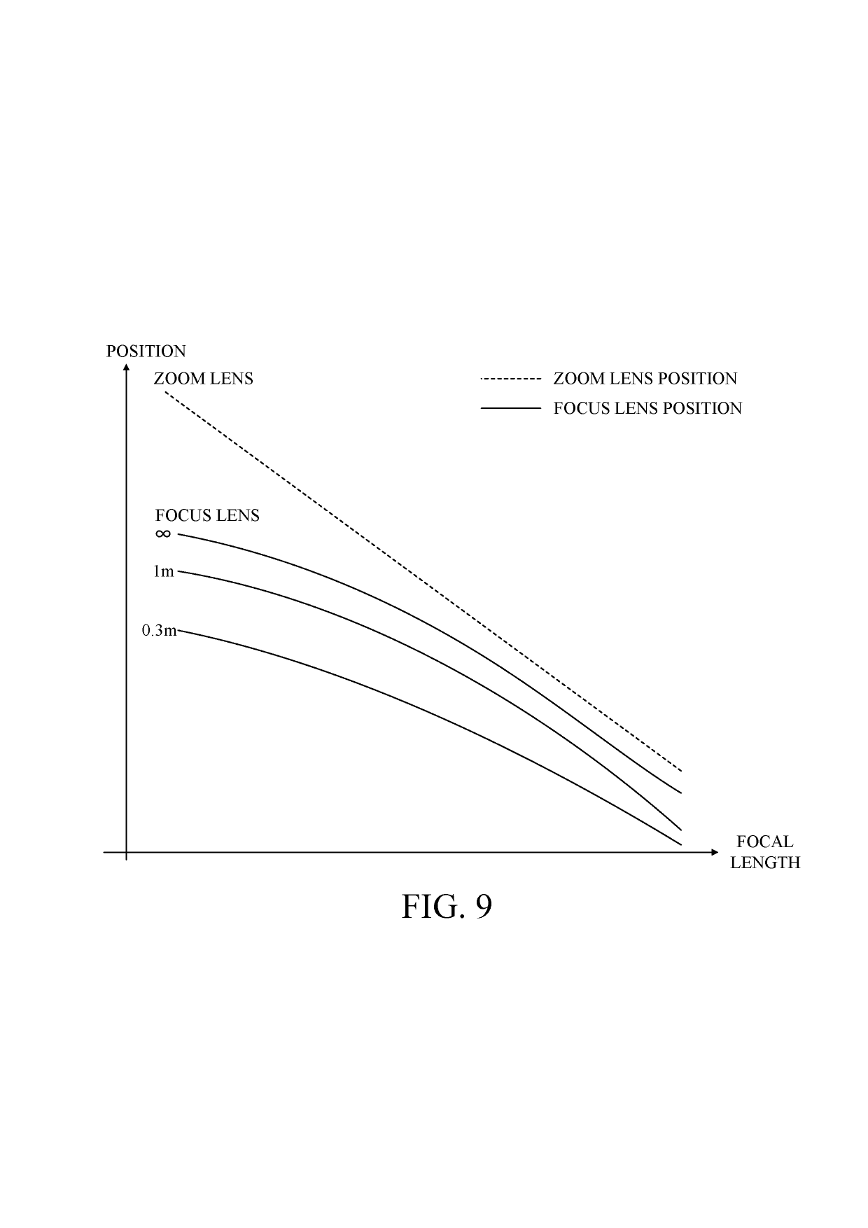

FIG. 9 illustrates a positional relationship between the zoom lens 104 and the focus lens 105. In FIG. 9, the horizontal axis represents the focal length, and the vertical axis represents the respective positions of the zoom lens 104 and the focus lens 105. FIG. 9 is a representation of FIG. 8 with the horizontal axis changed to focal length. In FIG. 9, the ideal position of the focus lens 105 (electronic cam data) at each object distance is represented by a solid line relative to the position of the zoom lens 104 illustrated by the dotted line.

It is understood from FIG. 9 that the respective positions of the zoom lens 104 and the focus lens 105 are closest to each other during the tracking control at an infinity object distance. At object distances of 1m or 0.3m relative to infinity, the zoom lens 104 and the focus lens 105 are further apart from each other, so there is no likelihood of collision. In the tracking control at a specific object distance where these lenses are close to each other, as illustrated in FIG. 9, this embodiment corrects the tracked position when the zoom lens 104 and the focus lens 105 are driven by performing the advance angle control, thereby preventing collision between these lenses.

### CONTROL METHOD OF LENS APPARATUS

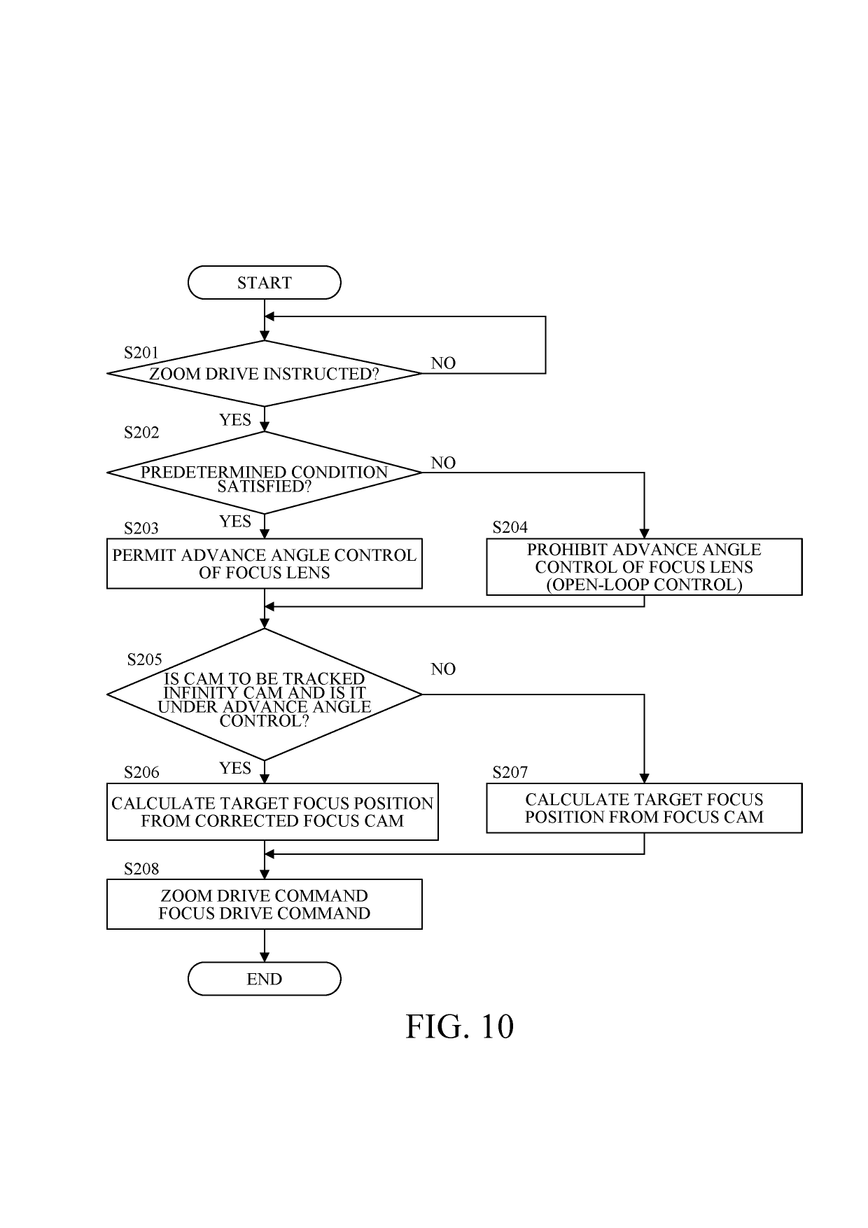

Next, with reference to FIG. 10, the control method of the lens apparatus 100 in this embodiment will be described. Each step in FIG. 10 is mainly executed by the lens microcomputer 120, or by each part according to the command of the lens microcomputer 120. However, this embodiment is not limited to this example, and may be executed by the camera microcomputer 210, or by each part according to the command of the camera microcomputer 210. In FIG. 10, steps S201 to S204 are similar to steps S101 to S104 in FIG. 7, so a description thereof will be omitted.

In step S205, the lens microcomputer 120 determines whether or not to correct the electronic cam data that is to be tracked for the tracking control to operate the focus lens 105 to maintain the object distance relative to the operation of the zoom lens 104. That is, the lens microcomputer 120 determines whether or not at least one of the zoom lens 104 and the focus lens 105 is under the advance angle control. The lens microcomputer 120 also determines whether or not the positions of the zoom lens 104 and the focus lens 105 are tracking an electronic cam where they are close to each other (in this embodiment, the infinity cam in FIG. 9). In a case where it is under the advance angle control and the electronic cam being tracked is the infinity cam, the flow proceeds to step S206. On the other hand, in a case where it is not under the advance angle control, or in a case where the electronic cam being tracked is not the infinity cam, the flow proceeds to step S207.

In step S206, the lens microcomputer 120 calculates the target focus position (target position) based on the infinity cam data stored as electronic cam data and the position of the zoom lens 104. At this time, the lens microcomputer 120 calculates the target focus position based on the amount of speed fluctuation of the zoom lens 104, or based on the position where the zoom lens 104 has advanced by one depth of field (a predetermined amount), which is an indicator by which the user can recognize that the image is out of focus. Thereby, the target focus position is calculated as a position further away from the zoom lens 104.

However, this embodiment is not limited to this example, and may use a method in which a predetermined amount (a predetermined correction amount) is corrected after calculating the target focus position from the position of the zoom lens 104. The predetermined amount may be, for example, one depth of field, which is an indicator by which the user can recognize that the image is out of focus. Alternatively, it may be the shift amount from the ideal position calculated from the speed fluctuation during the advance angle control. That is, the predetermined amount may be within one depth of field, or the shift amount from the ideal position calculated during feedback control.

The correction amount may be changed according to whether both the zoom lens 104 and the focus lens 105 are under the advance angle control, or only one of them is under the advance angle control. Since the amount of speed fluctuation also changes depending on the driving speed, the correction amount may also be changed based on the driving speed. As discussed above, the electronic cam data only stores data for representative points of multiple object distances corresponding to the positions of the zoom lens. Therefore, it is possible that the position is between the infinity cam and the 1m cam in FIG. 9. In that case, the cam data is calculated from the interpolation ratio, but the correction amount may also be changed based on the interpolation ratio.

In step S207, the lens microcomputer 120 calculates the target focus position using the stored cam data without correction.

Next, in step S208, the lens microcomputer 120 outputs drive commands to the zoom lens control unit 109 and the focus lens control unit 110, respectively, based on the target focus position calculated in step S206 or step S207.

Thus, in a case where the lens microcomputer 120 controls at least one of the stepping motors 111 and 115 with the feedback control, it corrects the target focus position of the focus lens 105 so that the focus lens 105 moves away from the zoom lens 104. For example, the lens microcomputer 120 calculates the target focus position of the focus lens 105 assuming that the zoom lens 104 is located at a position advanced by a predetermined amount, using the electronic cam data obtained from the memory 121. For example, the lens microcomputer 120 calculates a provisional target position (provisional target focus position) of the focus lens 105 using the cam data obtained from the memory 121, and calculates the target focus position by correcting the temporary target position by a predetermined amount.

Japanese Patent Application Laid-Open No. 2015-22136 does not disclose a configuration for independently controlling a plurality of lenses. In this configuration, a lens apparatus may have a reduced size and high optical performance.

As described above, this embodiment can avoid collisions by performing corrective driving only when there is a likelihood of collision, and otherwise perform accurate tracking control. Even in the corrective driving, by minimizing the corrective driving amount, a focus shift during the tracking control can be suppressed.

In each embodiment, the zoom lens 104 is the first lens and the focus lens 105 is the second lens, but it is not limited to this example. Each embodiment is applicable to a variety of combinations of lenses, such as a combination of a focus lens and a floating lens (aberration correction lens), or a combination of two zoom lenses, as the combination of the first and second lenses.

Each embodiment mounts an encoder capable of detecting the rotation angle on the stepping motor, properly performs feedback control to prevent step-out, and sets the movable ranges of multiple independently driven lenses so that they overlap each other. Thereby, each embodiment can reduce the size of the lens apparatus, achieve high image quality, and improve user convenience. Therefore, each embodiment can provide a lens apparatus, an image pickup apparatus, a control method for a lens apparatus, and a storage medium, each of which has a reduced size and high optical performance.

The memory 121 correspond to one or more memories storing instructions, and the lens microcomputer 120 corresponds to one or more processors that, upon execution of the instructions, operate to control the stepping motor (first stepping motor) 115 and the stepping motor (second stepping motor) 111 by switching between open-loop control and feedback control. The one or more memories and the one or more processors constitute a control apparatus. As described above, an unillustrated memory in the camera body 200 may correspond to the above one or more memories, and the camera microcomputer 210 may correspond to the above one or more processors.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012352, filed on January 28, 2025, which is hereby incorporated by reference herein in its entirety.

What is claimed is:

1. An optical apparatus comprising:
a first optical element movable within a first range in an optical axis direction;
a second optical element movable within a second range in the optical axis direction;
a first stepping motor configured to move the first optical element;
a second stepping motor configured to move the second optical element;
one or more memories storing instructions; and
one or more processors that, upon execution of the instructions, operate to control the first stepping motor and the second stepping motor by switching between open-loop control and feedback control,
wherein a part of each of the first range and the second range overlaps each other in the optical axis direction.

2. The optical apparatus according to claim 1, wherein the one or more memories store cam data indicating a relationship between a position of the first optical element and a position of the second optical element, and
wherein the one or more processors operate to:
control the second optical element using the cam data, and
switch between the open-loop control and the feedback control in the second stepping motor using at least one of the cam data, a speed of the first optical element, a control state of the first stepping motor, the position of the first optical element, the position of the second optical element, and a tracking delay amount of the second optical element relative to the first optical element in the cam data.

3. The optical apparatus according to claim 2, wherein the one or more processors operate to control the second stepping motor with the feedback control when the speed of the first optical element is higher than a predetermined speed.

4. The optical apparatus according to claim 2, wherein the one or more processors operate to control the second stepping motor with the feedback control when the tracking delay amount is larger than a predetermined amount.

5. The optical apparatus according to claim 2, wherein the one or more processors operate to control the second stepping motor with the feedback control when controlling the first stepping motor with the feedback control.

6. The optical apparatus according to claim 2, wherein the one or more processors operate to control the second stepping motor with the feedback control when a distance between the position of the first optical element and the position of the second optical element is smaller than a predetermined distance.

7. The optical apparatus according to claim 1, wherein the one or more processors operate to make, when controlling at least one of the first stepping motor and the second stepping motor with the feedback control, first power supplied to the first stepping motor and second power supplied to the second stepping motor different from each other.

8. The optical apparatus according to claim 7, wherein the one or more processors operate to:
make the second power more than the first power when the first optical element is moved in a first direction, and
make the first power more than the second power when the first optical element is moved in a second direction opposite to the first direction.

9. The optical apparatus according to claim 1, wherein the one or more processors operate to correct, when controlling at least one of the first stepping motor and the second stepping motor with the feedback control, a target position of the second optical element so that the second optical element moves away from the first optical element.

10. The optical apparatus according to claim 9, wherein the one or more processors operate to calculate the target position of the second optical element using cam data obtained from the one or more memories, assuming that the first optical element is located at a position advanced by a predetermined amount.

11. The optical apparatus according to claim 9, wherein the one or more processors operate to:
calculate a provisional target position of the second optical element using cam data obtained from the one or more memories, and
calculate the target position by correcting the provisional target position by a predetermined amount.

12. The optical apparatus according to claim 10, wherein the predetermined amount is within one depth of field, or is a shift amount from an ideal position calculated during the feedback control.

13. The optical apparatus according to claim 1, wherein the one or more processors operate to perform a magnification variation operation by moving the first optical element in the optical axis direction.

14. The optical apparatus according to claim 1, wherein the first optical element is disposed closer to an object than the second optical element.

15. The optical apparatus according to claim 1, wherein the first optical element is a zoom optical element, and the second optical element is a focus optical element.

16. An image pickup apparatus comprising:
the optical apparatus according to claim 1; and
an image sensor.

17. A method for controlling an optical apparatus having a first optical element movable within a first range in an optical axis direction, and a second optical element movable within a second range in the optical axis direction, the method comprising:
controlling a first stepping motor configured to move the first optical element by switching between open-loop control and feedback control,
controlling a second stepping motor configured to move the second optical element by switching between the open-loop control and the feedback control;
wherein a part of each of the first range and the second range overlaps each other in the optical axis direction.

18. A non-transitory computer-readable storage medium storing a program that causes a computer to execute the method according to claim 17.

19. A control apparatus comprising:
one or more memories storing instructions; and
one or more processors that, upon execution of the instructions, operate to control a first stepping motor configured to move a first optical element that is movable within a first range in an optical axis direction and a second stepping motor configured to move a second optical element that is movable within a second range in the optical axis direction, by switching between open-loop control and feedback control,
wherein a part of each of the first range and the second range overlaps each other in the optical axis direction.

20. An image pickup apparatus comprising:
the control apparatus according to claim 19; and
an image sensor.
